(19) United States
(12) Patent Application Publication
(10) Pub. No.: US 2018/0248434 A1
(43) Pub. Date: Aug. 30, 2018

(54) ROTARY ELECTRICAL MACHINE WITH IMPROVED CONFIGURATION

(71) Applicant: Valeo Equipements Electriques Moteur, Creteil (FR)

(72) Inventors: Benoit Walme, Creteil (FR); Johnny Duarte, Creteil (FR); Mamy Rakotovao, Creteil (FR); Etienne Doyard, Creteil (FR)

(73) Assignee: Valeo Equipements Electriques Moteur, Creteil (FR)

(21) Appl. No.: 15/903,552

(22) Filed: Feb. 23, 2018

(30) Foreign Application Priority Data
Feb. 27, 2017 (FR) 1751528

(51) Int. Cl. H02K 3/28; H02K 1/16; H02K 1/27; H02K 3/12

(52) U.S. Cl. CPC H02K 3/28; H02K 1/16; B60H 1/3222; H02K 3/12; H02K 1/2746

(57) ABSTRACT

The invention relates mainly to a rotary electrical machine (10) comprising:
a rotor (12) comprising permanent magnets (39);
a stator (11) comprising a body (16) and a three-phase winding (25),
   characterised in that:
the coupling of the coils (26) is of the triangle-series type; and
the product of the number of turns of each coil (26), of the axial length of the stator body (16) expressed in mm, and of the inner diameter (L2) of the stator body (16) expressed in mm, is contained between 38998 and 39142;
the number of turns being contained between 23 and 37, the axial length of the stator body (16) being contained between 17 mm and 27 mm, and the inner diameter (L2) of the stator body (16) being contained between 62 mm and 67 mm.

The present invention relates to a rotary electrical machine with improved configuration. The invention has a particularly advantageous application in the field of rotary electrical machines, such as an alternator or an electric motor. The invention will advantageously be able to be used with an air conditioner coolant fluid compressor for a motor vehicle.

Electrical machines are known comprising a stator and a rotor integral with a shaft which ensures that a spiral compressor is put into motion, the latter being designated by the name of scroll. A system of this type comprises two spirals which cooperate with one another in order to pump and compress the coolant fluid. In general, one of the spirals is fixed, whereas the other is displaced eccentrically without rotating, such as to pump, then trap and compress pockets of fluid between the turns. A system of this type is described for example in document EP1865200.

The rotor of the electrical machine comprises a body formed by a stack of metal plate sheets which are retained in the form of a set by means of an appropriate securing system. The rotor comprises poles which are formed for example by permanent magnets situated in receptacles provided in the magnetic mass of the rotor. Alternatively, in a so-called “projecting” poles configuration, the poles are formed by coils which are wound around arms of the rotor.

In addition, the stator comprises a body made of laminated metal plates in order to decrease the Foucault currents. The body comprises an annular wall, known as a head, and teeth are obtained from the inner periphery of the annular wall. The teeth of the stator which are distributed on the head extend towards the interior of the stator in the direction of the rotor. An air gap exists between the free end of the teeth, defining the inner periphery of the stator body, and the outer periphery of the rotor. The teeth define together with the head notches which are open towards the interior, and are designed to receive a winding for formation of a polyphase stator, for example of the three-phase type. This winding can for example consist of a set of coils which are insulated electrically against the stator body, and are each wound around a corresponding tooth. This therefore provides a winding of the so-called concentrated type.

The objective of the invention is to improve the existing configuration of an electrical machine of this type.

For this purpose, the subject of the invention is a rotary electrical machine comprising:
a rotor comprising permanent magnets;
a stator comprising:
   a body provided with 15 teeth, the said body having an axial length and an inner diameter; and
   a three-phase winding comprising a plurality of coils, each coil formed by a plurality of turns surrounding a corresponding tooth,
      characterised in that:
the coupling of the coils is of the triangle-series type; and
the product of the number of turns of each coil, of the axial length of the stator body expressed in mm, and of the inner diameter of the stator body expressed in mm, is contained between 38998 and 39142;
the number of turns being contained between 23 and 37, the axial length of the stator body being contained between 17 mm and 27 mm, and the inner diameter of the stator body being contained between 62 mm and 67 mm.

Triangle-series means the fact that the coils of each phase are fitted in series relative to one another, and the assemblies of the phase coils are coupled in the form of a triangle.

The invention thus makes it possible to obtain an optimum compromise between the performance and size of the rotary electrical machine. The invention also makes it possible to reduce the weight of the machine and minimise the level of noise, whilst facilitating the implementation of the winding operations. It also facilitates the connection between the winding and the connector of the power module by minimising the number of phase wires to be connected.

According to one embodiment, the stator body has an outer diameter of 94 mm plus or minus 20%.

According to one embodiment, the axial length of the stator body is approximately 20 mm plus or minus 20%.

According to one embodiment, a number of turns of each coil is approximately 32 plus or minus 20%.

According to one embodiment, a thickness of the stator head is approximately 4.5 mm plus or minus 20%.

According to one embodiment, a wire diameter of each coil is approximately 0.8 mm plus or minus 20%.

According to one embodiment, the rotor comprises 10 poles.

According to one embodiment, the rotor comprises:
a body comprising teeth and receptacles between the teeth;
at least one permanent magnet positioned in each receptacle;
the body additionally comprising a hub which is designed to be fitted on a shaft;
each tooth comprising at least two arms for connection to the hub, each arm forming a portion of an edge of a receptacle of a corresponding permanent magnet.

According to one embodiment, a recess is formed between the two arms of a single tooth.

According to one embodiment, at least one tooth comprises a securing hole which can receive a securing unit, and a gap between an edge of the securing hole and an edge of the corresponding recess is constant.

According to one embodiment, the rotor comprises means for radial retention of the permanent magnets.

According to one embodiment, the means for radial retention are constituted by lips which extend on both sides of the teeth of the rotor.

According to one embodiment, the said electrical machine comprises units for positioning of the permanent magnets against the corresponding lips.

According to one embodiment, each positioning unit is positioned in a corresponding receptacle between the hub and the corresponding permanent magnet.

According to one embodiment, the said rotary electrical machine is configured to operate at a voltage lower than 350 V.

The invention will be better understood by reading the following description and examining the figures which accompany it. These figures are provided purely by way of illustration, and in no way limit the invention.

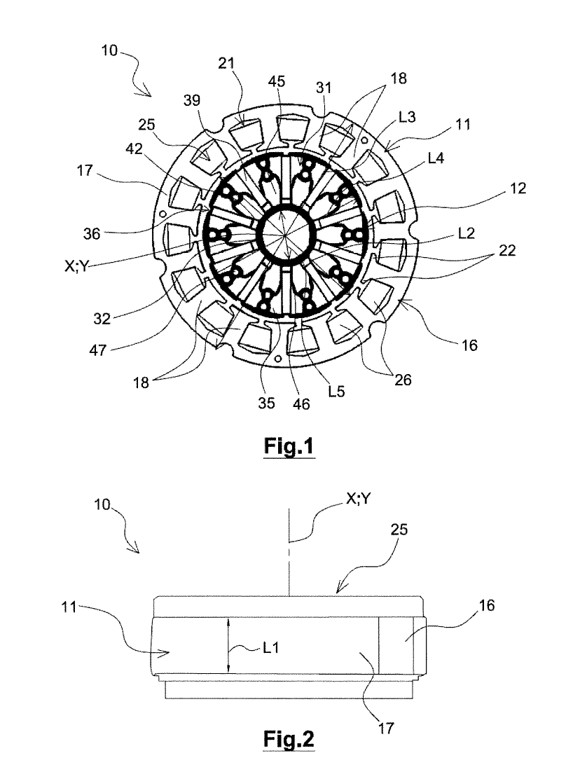

FIG. 1 is a view in transverse cross-section of a rotary electrical machine according to the present invention.

FIG. 2 is a side view of the rotary electrical machine according to the present invention.

FIG. 3 is a view from above of the rotary electrical machine according to the present invention.

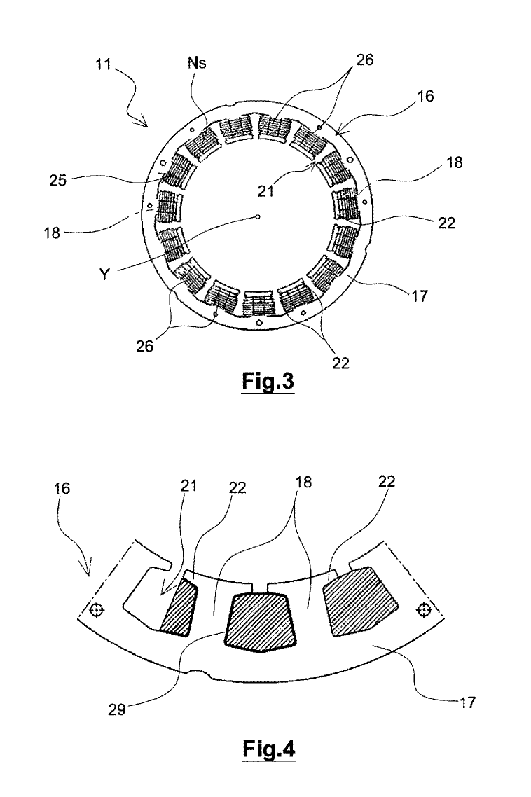

FIG. 4 is a view in partial cross-section of the stator of the rotary electrical machine according to the present invention.

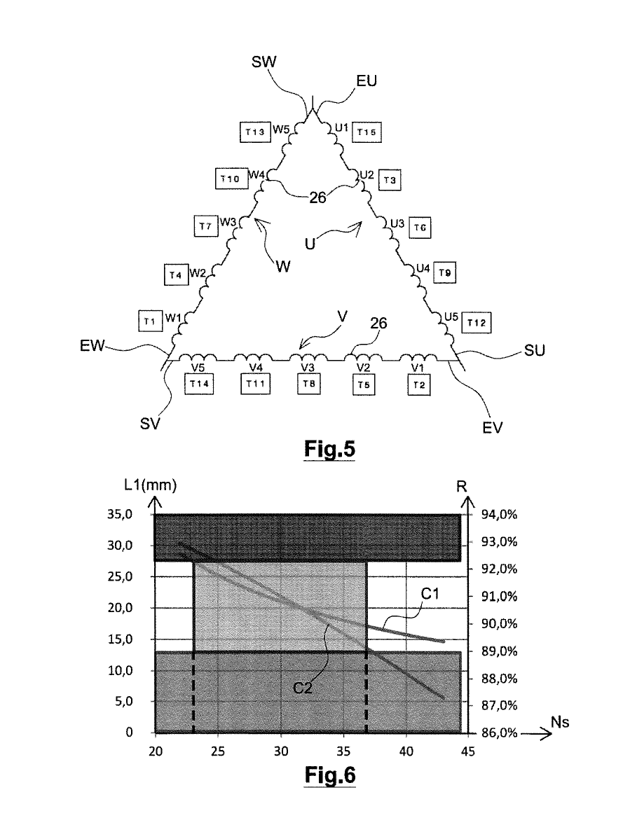

FIG. 5 is a schematic representation of the coupling in the form of a triangle of the phases of the rotary electrical machine according to the present invention.

FIG. 6 is a graphic representation of the development of the parameters of performance and axial length of the stator body of the electrical machine according to the number of turns for each coil.

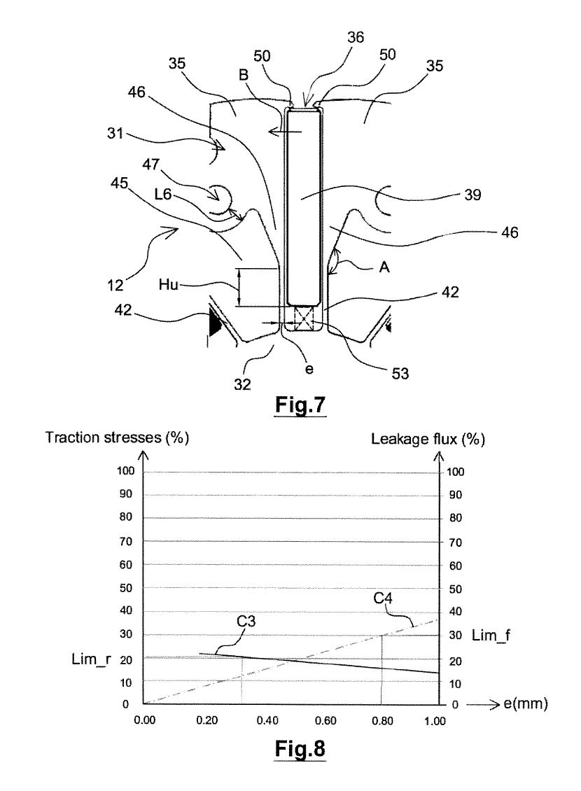

FIG. 7 is a detailed view illustrating the area of overlapping between a magnet and connection arms of the rotor of the rotary electrical machine according to the present invention.

FIG. 8 is a representation of the development of the leakage flux passing via the arm of the rotor, and of the mechanical stresses applied to the set of metal plates of the rotor according to the thickness of a connection arm of the rotor.

Elements which are identical, similar or analogous retain the same reference from one figure to another.

FIG. 1 represents a rotary electrical machine 10 comprising a polyphase stator 11 surrounding a rotor 12 with an axis X which is designed to be fitted on a shaft (not represented). The stator 11 is designed to be supported by a casing (not represented) configured to support the shaft such as to rotate via ball bearings and/or needle bearings, as can be seen for example in the aforementioned document EP1865200. This rotary electrical machine 10 can belong to a compressor used for the compression of motor vehicle air conditioner coolant fluid. As a variant, the machine 10 can operate in alternator mode. Preferably, the rotary electrical machine 10 is advantageously configured to operate at a voltage lower than 350 V.

As can be seen in FIG. 3, the stator 11 has an axis Y which is designed to be combined with the axis X of the rotor 12 when the machine 10 is in an assembled state. The stator 11 comprises a body 16 in the form of a set of laminated metal plates which has on its outer periphery an annular wall 17 known as a head, and teeth 18 obtained from the inner periphery of the head 17, as represented in FIG. 4. These teeth 18 are distributed circumferentially regularly and extend towards the interior in the direction of the rotor 12, such as a rotor with permanent magnets described in greater detail hereinafter.

The teeth 18 delimit in pairs notches 21, two successive notches 21 thus being separated by a tooth 18. These teeth 18 each have at their free end two rims 22 which extend circumferentially on both sides of the tooth 18. The free ends of the teeth 18 delimit in a known manner an air gap with the outer periphery of the rotor 12 of the rotary electrical machine 10.

The stator 11 also comprises a three-phase winding 25 comprising a plurality of coils 26 in order to form the different poles of the stator 11. Each coil 26 is formed by a plurality of turns surrounding a corresponding tooth 18. The coils 26 are produced such that a single notch 21 receives two half coils. This therefore provides a winding 25 of the so-called concentrated type.

The wires of the windings 26, such as wires made of copper or aluminium covered with an electrically insulating layer, such as enamel for example, are each wound around a tooth 18. This winding operation 25 can for example be carried out by means of a needle which is hollow in its centre in order to permit the passage of one or a plurality of parallel wires forming the coil 26. This needle is displaced circumferentially, axially, and radially relative to the stator 11. The winding 25 can be produced in situ, i.e. directly around teeth 18 of the stator 11. Alternatively, the winding 25 can be produced on added-on teeth 18, which are then secured on the head of the stator 11 via an appropriate connection system.

Preferably, the stator 11 is equipped with notch insulators 29, taking for example the form of a fine membrane produced from an electrically insulating and heat-conducting material. This fine membrane is folded, such that each notch insulator 29 is interposed between a coil 26 and the inner walls of the notches 21 of the stator 11.

As illustrated in FIG. 5, there can be distinguished amongst the coils 26 the coils Ui which are used to form the phase U of the machine, the coils Vi which are used to form the phase V of the machine, as well as the coils Wi which are used to form the phase W of the machine, for i going from 1 to N. In this case, N equals 5, but as a variant it could have a higher or lower value, whilst remaining equal to at least two.

More specifically, Tj corresponds to a tooth 18 of the stator 11 with j going from 1 to 15 for a stator with 15 teeth. The coils are associated alternately with the different phases of the stator 11. Thus, for a system with three phases U, V, W, the coil of the tooth T1 is associated with the phase W, the coil of the tooth T2 is associated with the phase V, the coil of the tooth T3 is associated with the phase U, and so on. This therefore means that the coils 26 are associated with a single phase every K teeth, K being the number of phases which in this case is equal to 3.

In addition, the coils 26 of each phase U, V, W are connected electrically in series. Thus, the coils UI, U2, U3, U4, U5 of the phase U are connected electrically in series. The coils V1, V2, V3, V4, V5 of the phase V are connected electrically in series, and the coils W1, W2, W3, W4, W5 of the phase W are connected electrically in series.

The phases U, V, W of the machine 10 are advantageously coupled in the form of a triangle. Thus, the input EU of the phase U is connected to the output SW of the phase W. The input EW of the phase W is connected to the output SV of the phase V. The input EV of the phase V is connected to the output SU of the phase U.

In order to increase the performance of the machine 10, it is necessary to reduce its resistance whilst increasing the section which can be wound, as well as the number of turns Ns of each coil 26 and the axial length L1 of the stator body 16 (cf. FIG. 2). For the same level of filling, the reduction of the number of turns Ns corresponds to an increase in the diameter of the wire. In addition, in order to improve the compactness of the machine 10, it is necessary to reduce the length L1 of the stator body 16, whilst maintaining the same torque. For this purpose, it is necessary to increase the number of turns Ns.

In order to optimise the compromise between the performance and the compactness, whilst having a performance equal to 89% or more and an axial length L1 of the stator body 16 equal to 27 mm or less, the product of the number of turns Ns of each coil 26, of the axial length L1 of the stator body 16 expressed in millimetres, and of the inner diameter L2 of the stator body 16 expressed in millimetres, i.e. the product of Ns×L1×L2, is contained between 38998 and 39142.

Preferably, the number of turns Ns is contained between 23 and 37, the axial length L1 of the stator body 16 is contained between 17 mm and 27 mm, and the inner diameter L2 of the stator body 16 is contained between 62 mm and 67 mm.

The table below gives examples of values for an inner diameter L2 of the stator body 16 of 62 mm:

| Line number | Number of turns Ns | Length L1 | Performance R |
|---|---|---|---|
| 1 | 22 | 28.7 | 92.9% |
| 2 | 25 | 25.2 | 92.2% |
| 3 | 28 | 22.5 | 91.5% |
| 4 | 31 | 20.3 | 90.7% |
| 5 | 34 | 18.5 | 89.9% |
| 6 | 37 | 17.0 | 89.1% |
| 7 | 40 | 15.8 | 88.2% |
| 8 | 43 | 14.7 | 87.3% |

The curves C1 and C2 corresponding respectively to the length L1 and to the performance R are represented in FIG. 6. It can be seen that the values of the first line do not correspond to an acceptable configuration, since they do not make it possible to comply with the criterion of compactness (L1 greater than 27 mm). In addition, the values of the lines 7 and 8 do not make it possible to comply with the performance criterion imposed (R less than 89%).

The table below gives examples of values for an inner diameter L2 of the stator body 16 of 67 mm:

| Line number | Number of turns Ns | Length L1 | Performance R |
|---|---|---|---|
| 1 | 17 | 34.3 | 93.4% |
| 2 | 20 | 29.2 | 92.6% |
| 3 | 23 | 25.4 | 91.7% |
| 4 | 26 | 22.4 | 90.8% |
| 5 | 29 | 20.1 | 89.8% |
| 6 | 32 | 18.2 | 88.8% |
| 7 | 35 | 16.7 | 87.7% |
| 8 | 38 | 15.4 | 86.6% |

It can be seen that the values of lines 1 and 2 do not correspond to acceptable configurations, since they do not make it possible to comply with the criterion of compactness (L1 greater than 27 mm). In addition, the values of the lines 6, 7 and 8 do not make it possible to comply with the performance criterion (R less than 89%).

According to a particular embodiment, the stator body 16 has an outer diameter L3 of 94 mm plus or minus 20%. The axial length L1 of the stator body 16 is approximately 20 mm plus or minus 20%. The number of turns Ns of each coil 26 is approximately 32 plus or minus 20%. A thickness of the stator 11 head 17 is approximately 4.5 mm plus or minus 20%. The wire diameter of each coil 26 is approximately 0.8 mm plus or minus 20%.

In addition, as can be seen in FIGS. 1 and 7, the rotor 12 with an axis X comprises a body 31 formed by a set of laminated metal plates constituted by an axial stack of ferromagnetic metal plates. The rotor 31 body comprises a hub 32 fitted on the shaft of the machine, and teeth 35 which extend radially relative to the hub 32. Receptacles 36 are situated between the teeth 35. Each receptacle 36 is delimited by two consecutive teeth 35, such that there is circumferential alternation between the teeth 35 and the receptacles 36.

At least one permanent magnet 39 is positioned in each receptacle 36. Thus, it will be possible to use a single magnet 39 positioned inside a corresponding receptacle 36, or two magnets 39, or even more than two magnets per receptacle 36, stacked axially on one another.

The magnets 39 extend radially relative to the axis X of the rotor 12. This therefore provides a rotor 12 configuration with a concentration of flux, with the opposite lateral faces of two consecutive magnets 39 having the same polarity. The magnets 39 are preferably made of rare earth. As a variant, the magnets 39 are made of ferrite according to the applications and power required for the rotary electrical machine 10. In this case, the rotor 12 comprises ten receptacles 36 and therefore ten poles.

In addition, each tooth 35 comprises two arms 42 for connection to the hub 32, as can be seen clearly in FIG. 7. Each arm 42 forms a portion of an edge of a receptacle 36 for a corresponding magnet 39. Each arm 42 comprises a part for overlapping with a magnet 39 corresponding to the part of the arm 42 opposite the magnet 39, having a radial length Hu and a thickness e measured in a direction which is orthoradial relative to the axis X.

Preferably, in order to obtain an optimum compromise between the magnetic performance and the mechanical rigidity of the rotor 12, the ratio between the radial length Hu and the thickness e of an arm 42 is contained between 1.8 divided by the field B of the corresponding magnet 39 and 2.16 divided by the field B of the corresponding magnet 39.

In FIG. 8 where the curves C3 and C4 represent respectively the development of the mechanical stresses applied to the set of metal plates of the rotor and the development of the leakage flux, the thickness e of an arm 42 is contained between 0.3 mm and 0.8 mm, in order to comply with the breaking point of the set of metal plates Lim_r and the maximum permissible leakage flux Lim_f.

In addition, a recess 45 is formed between the two arms 42 of a single corresponding tooth 35. The tooth 35 comprises a widened portion 46 which extends in the extension of each arm 42 forming a face of the recess 45. This face forms an angle A of at least 150° with a face of the arm 42, forming another face of the corresponding recess 45.

According to one embodiment, the rotor 12 has an outer diameter L4 contained between 60 mm and 70 mm, and an inner diameter L5 contained between 15 and 20 mm (cf. FIG. 1). The thickness of each arm 42 is contained between 0.4 and 0.6 mm, and is preferably approximately 0.5 mm. The useful length of the overlapping Hu is contained between 0.7 mm and 4.2 mm.

In the example represented in FIGS. 1 and 7, each tooth 35 additionally comprises a securing hole 47 which can receive a securing unit, such as a rivet, in order to keep the metal plates of the rotor 12 together. In order to optimise the passage of the flux in the tooth 35, a gap L6 measured on a plane perpendicular to the axis X, between an edge of the securing hole 47 and an edge of the corresponding recess 45, is constant. As a variant, some teeth 35 of the rotor 12 comprise a securing hole 47, but not all of them.

In addition, lips 50 are implanted on the free end side of each tooth 35. These lips 50 extend on both sides of each tooth 35. These lips 50 thus constitute means for radial retention of the magnets 39. As a variant, receptacles 36 for the magnets 39 can be closed on their outer periphery.

Positioning units 53, such as flat springs, ensure the positioning of the magnets 39 against the corresponding lips 50, as illustrated by FIG. 7. Each positioning unit 53 is positioned in a corresponding receptacle 36 between the hub 32 and the corresponding magnet 39.

It will be appreciated that the foregoing description has been provided purely by way of example, and does not limit the field of the invention, a departure from which would not be constituted by replacement of the different elements by any other equivalents.

In addition, the different characteristics, variants, and/or embodiments of the present invention can be associated with one another according to different combinations, provided that they are not incompatible with one another or mutually exclusive.

1. A rotary electrical machine comprising:
a rotor comprising permanent magnets; and
a stator comprising:
a body provided with 15 teeth, the body having an axial length and an inner diameter; and
a three-phase winding comprising a plurality of coils, each coil formed by a plurality of turns surrounding a corresponding tooth, wherein:
the coupling of the coils is of the triangle-series type,
the product of the number of turns of each coil, of the axial length of the stator body expressed in mm, and of the inner diameter of the stator body expressed in mm, is contained between 38998 and 39142, and
the number of turns (Ns) is contained between 23 and 37, the axial length of the stator body is contained between 17 mm and 27 mm, and the inner diameter of the stator body being contained between 62 mm and 67 mm.

2. The rotary electrical machine according to claim 1, wherein the stator body has an outer diameter of 94 mm plus or minus 20%.

3. The rotary electrical machine according to claim 1, wherein the axial length of the stator body is approximately 20 mm plus or minus 20%.

4. The rotary electrical machine according to claim 1, wherein a number of turns of each coil is approximately 32 plus or minus 20%.

5. The rotary electrical machine according to claim 1, wherein a thickness of the stator head is approximately 4.5 mm plus or minus 20%.

6. The rotary electrical machine according to claim 1, wherein a wire diameter of each coil is approximately 0.8 mm plus or minus 20%.

7. The rotary electrical machine according to claim 1, wherein the rotor comprises 10 poles.

8. The rotary electrical machine according to claim 1, wherein the rotor comprises:
a body comprising teeth and receptacles between the teeth;
at least one permanent magnet positioned in each receptacle;
the body additionally comprising a hub which is designed to be fitted on a shaft;
each tooth comprising at least two arms for connection to the hub, each arm forming a portion of an edge of a receptacle of a corresponding permanent magnet.

9. The rotary electrical machine according to claim 8, wherein a recess is formed between the two arms of a single tooth.

10. The rotary electrical machine according to claim 9, wherein at least one tooth comprises a securing hole which can receive a securing unit, and a gap between an edge of the securing hole and an edge of the corresponding recess is constant.

11. The rotary electrical machine according to claim 8, wherein the rotor comprises means for radial retention of the permanent magnets.

12. The rotary electrical machine according to claim 11, wherein the means for radial retention are constituted by lips which extend on both sides of the teeth of the rotor.

13. The rotary electrical machine according to claim 8, further comprising units for positioning of the permanent magnets towards the corresponding lips.

14. The rotary electrical machine according to claim 8, wherein each positioning unit is positioned in a corresponding receptacle between the hub and the corresponding permanent magnet.

15. The rotary electrical machine according to claim 1, wherein the rotary electrical machine is configured to operate at a voltage lower than 350 V.
